(19) United States
(12) Patent Application Publication
(10) Pub. No.: US 2006/0248315 A1
(43) Pub. Date: Nov. 2, 2006

(54) Stack controller efficiently using the storage capacity of a hardware stack and a method therefor

(75) Inventor: Yuji Honda, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Minato-ku (JP)

(21) Appl. No.: 11/369,822

(22) Filed: Mar. 8, 2006

(30) Foreign Application Priority Data
Apr. 28, 2005 (JP) 2005-131343

(51) Int. Cl. G06F 9/30

(52) U.S. Cl. 712/202

(57) ABSTRACT

In a stack controller for use in a microprocessor when executing a program sequence, an interrupt controller monitors the number of free entries of a hardware stack to generate, when the free entry number reaches a number of push- or pop-trigger entries, a push or pop interrupt to send the interrupt to a main controller. In response to the push interrupt, the main controller retrieves data from the bottom of the hardware stack and pushes the data onto the software stack. The main controller repeats this sequence the times equal to a predetermined number of saving entries to perform push interrupt processing. In response to the pop interrupt, the main controller pops data from the software stack and stores the popped data at the bottom of the hardware stack. The main controller repeats this sequence the times equal to a predetermined number of restoring entries to perform pop interrupt processing.

### BACKGROUND OF THE INVENTION

1. Field of the Invention

The present invention relates to a stack controller for use in a processor system such as a microprocessor when executing a program sequence, and to a method therefor.

2. Description of the Background Art

Conventionally, a microprocessor that executes the same program multiple times defines the processing part of that program as a subroutine for efficient program execution. When an instruction that calls such a subroutine is executed, a calling program pushes the return address, which points to the routine to be processed immediately after the subroutine, onto a stack and then passes control to the start address of the subroutine. When the processing of the subroutine is terminated, the program executes the return-from-subroutine instruction, pops the return address from the stack, and passes control to the address.

To speedily push onto and pop from the stack during program execution, such a microprocessor has a stack register provided in its hardware and, as the program progresses, automatically pushes or pops a program counter, a loop counter, and a loop end address onto and from the stack under hardware control.

In a microprocessor, when the stack capacity is exceeded during program execution, a program sequence halts unexpectedly or a program runaway problem is generated due to a missing return-from-subroutine address. Since an attempt to simply increase the capacity of the stack to solve those programs would result in an endless increase in the hardware size, other solutions are known.

For example, Japanese patent laid-open publication No. 77004/1996 discloses a memory management method in which, when the bus management feature detects an interrupt causing a stack area to overflow, the address of the stack area, pointed to by a stack pointer, is saved and the address of a free area in a random-access memory (RAM) is set in the stack pointer to continue the process.

European patent application publication No. EP0720087 A1 discloses a memory extension stack circuit that performs the following operation in a data processing system. When the hardware stack is almost full, the move instruction is inserted into a program sequence in execution to move the last entry in the hardware stack to a memory extension stack. When the hardware stack is almost empty, the move instruction is inserted into the program sequence to move an entry from the memory extension stack to the end of the hardware stack. In this way, the program keeps the hardware running.

The problem with the memory management method disclosed in the Japanese patent publication is that the stack is usually prepared in the main memory and, in addition, allocated to the extension stack are frequently-used, most-recent data. Therefore, this memory management method is not suitable for high-speed processing.

The problem with the memory extension stack circuit disclosed in the European patent publication is that the control logics manage and process all processing for the hardware stack and the memory extension stack. Therefore, the control logics tend to become large and complicated.

### SUMMARY OF THE INVENTION

It is an object of the present invention to provide a stack controller for and a method of executing a program sequence continuously without halting or runaway and without increase in hardware size or circuit complexity even when the stack register capacity is exceeded during program execution.

In accordance with the present invention, a stack controller comprises a main controller for executing a program sequence including a plurality of instructions such as an operation instruction and a subroutine call instruction; a stack register having a first stack where first data are stored in a Last-In Fast-Out (LIFO) fashion, the first data including a program counter, a loop counter and a loop end address of the predetermined program; and a storage circuit for temporarily storing second data such as an intermediate result processed by the operation instruction. The storage circuit includes a second stack where the first data are stored in a LIFO fashion. The stack controller further comprises an interrupt controller that monitors a capacity of the first stack. When a number of free entries of the first stack has reached a predetermined number of push-trigger entries, the interrupt controller generates a push interrupt and sends the generated push interrupt to the main controller. When the number of free entries has reached a predetermined number of pop-trigger entries, the interrupt controller generates a pop interrupt and sends the generated pop interrupt to the main controller. The main controller comprises a push interrupt processor operative in response to the push interrupt for repeatedly retrieving data from a bottom of the first stack and then pushing the retrieved data onto the second stack a number of times equal to a predetermined number of restoring entries; and a pop interrupt processor operative in response to the pop interrupt for repeatedly popping data from the second stack and then storing the popped data at the bottom of the first stack a number of times equal to a predetermined number of restoring entries.

Also in accordance with: the present invention, a stack control method comprises the steps of: executing by a main controller a program sequence including a plurality of instructions such as an operation instruction and a subroutine call instruction; storing first data in a first stack in a stack register in a LIFO fashion, the first data including a program counter, a loop counter and a loop end address of the predetermined program; and temporarily storing second data, such as an intermediate result processed by the operation instruction, into a memory. The method further comprises the steps of: storing the first data into a second stack in the memory in a LIFO fashion; monitoring a capacity of the first stack and generating, when a number of free entries of the first stack has reached a predetermined number of push-trigger entries, a push interrupt and sending the generated push interrupt to the main controller, and, when the number of free entries has reached a predetermined number of pop-trigger entries, a pop interrupt to send the generated pop interrupt to the main controller; repeatedly retrieving data in response to the push interrupt, by the main controller, from a bottom of the first stack and then pushing the retrieved data onto the second stack a number of times equal to a predetermined number of restoring entries; and repeatedly popping data in response to the pop interrupt, by the main controller, from the second stack and then storing the popped data at the bottom of the first stack a number of times equal to a predetermined number of restoring entries.

In accordance with the stack controller according to the present invention, the interrupt controller generates a push interrupt before the hardware stack is filled to allow the main controller to retrieve data from the bottom of the hardware stack and push the retrieved data onto the software stack to temporarily save it. After free entries are created in the hardware stack, the interrupt controller generates a pop interrupt to allow the main controller to pop data from the software stack and restore the popped data at the bottom of the hardware stack. In this way, the stack controller according to the present invention allows a program to be executed continuously without program halting or runaway and without increase in the size or scale and complexity of the main controller even when the hardware stack capacity is exceeded during program execution.

In accordance with the stack controller according to the present invention, multiple data entries can be saved from or restored to the hardware stack at a time. This feature reduces the frequency at which push or pop interrupts are generated and prevents performance degradation that would be otherwise be caused by push and pop interrupts.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing an embodiment of a stack controller according to the present invention;

FIG. 2 is a schematic block diagram showing a part of a stack register in the stack controller shown in FIG. 1;

FIG. 3 is a flowchart useful for understanding the operation procedure for a push interrupt in the stack controller shown in FIG. 1;

FIGS. 4 through 7 schematically show data stored in the hardware and software stacks during the operation shown in FIG. 3;

FIG. 8 is a flowchart useful for understanding the operation procedure for a pop interrupt in the stack controller shown in FIG. 1;

FIGS. 9 through 12 schematically show data stored in the hardware stack and the software stack during the operation in FIG. 8;

FIGS. 13 through 16 schematically show data stored in the hardware stack and the software stack during the operation in FIG. 3;

FIGS. 17 through 20 schematically show data stored in the hardware stack and the software stack during the operation in FIG. 8;

FIG. 21 shows an example of a program sequence executed in the stack controller shown in FIG. 1; and

FIGS. 22 through 29 schematically show data stored in the hardware stack and the software stack in a modification of the stack controller shown in FIG. 1.

### DESCRIPTION OF THE PREFERRED EMBODIMENT

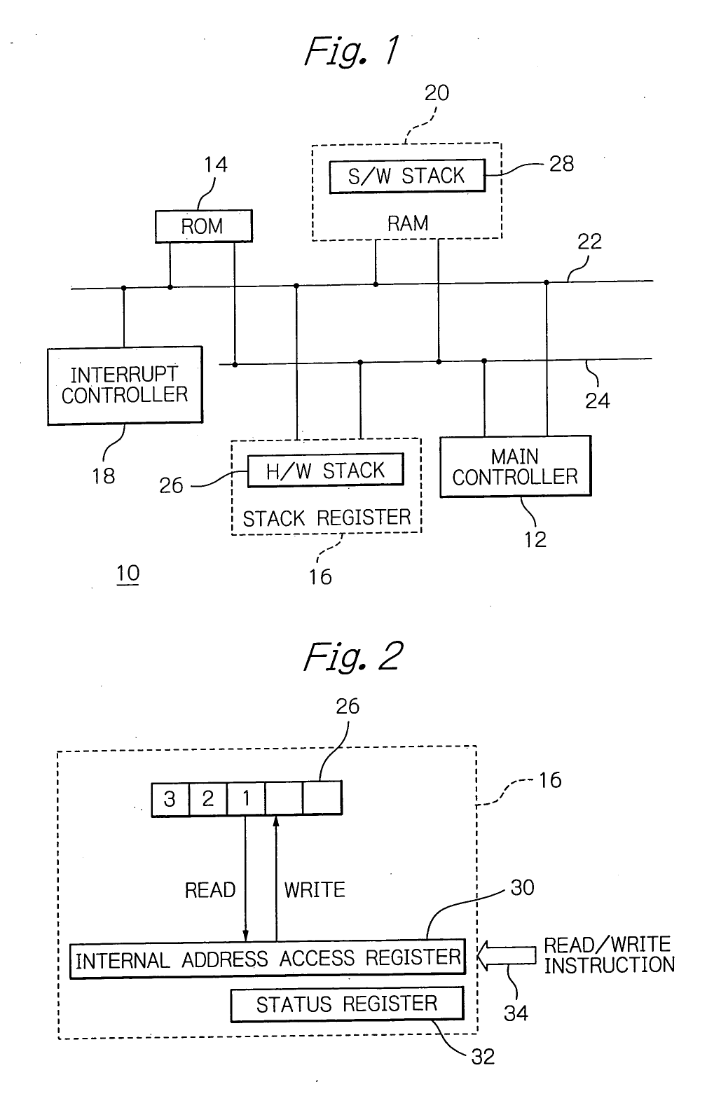

With reference to the accompanying drawings, a preferred embodiment of a stack controller according to the present invention will be described in detail. As shown in FIG. 1, a stack controller 10 according to the present invention is adapted to store data, such as a subroutine return address, into a stack register 16 when a main controller 12 executes a program sequence stored in a read-only memory (ROM) 14. In order to prevent data to be stored in the stack register 16 from exceeding the capacity thereof, an interrupt controller 18 is provided to transfer the data between a hardware (H/W) stack 26 allocated in the stack register 16 and a software (S/W) stack 28 allocated in a random access memory (RAM) 20. For simplicity, parts or components not directly related to understanding the present invention will neither be described nor shown.

In the stack controller 10 in accordance with the illustrative embodiment, the main controller 12, the ROM 14, the stack register 16, the interrupt controller 18 and the RAM 20 are interconnected as illustrated with a control bus 22, over which control signals are transferred. The main controller 12, the ROM 14, the stack register 16, the interrupt controller 18, and the RAM 20 are also interconnected with a data bus 24, over which data signals are transferred.

The main controller 12, generally comprised of a CPU (Central Processing Unit), is adapted for controlling and managing the overall operation of the stack controller 10, and specifically for sequentially reading out instructions of program sequences from the ROM 14 for execution. The main controller 12 pushes and pops data for a program counter, a loop counter and loop end addresses used during program execution, onto and from the hardware stack 26.

For example, when a subroutine call instruction is to be executed, the main controller 12 pushes a subroutine return address therefor onto the hardware stack 26, processes the subroutine, pops a return address therefor from the hardware stack 26 after processing the subroutine, and continues the processing of the instruction associated with the return address. Also, when the main controller 12 receives an external interrupt instruction from the interrupt controller 18, the main controller 12 pushes a return address pointing to an instruction immediately following the current instruction onto the hardware stack 26, thereafter processes the external interrupt, and pops the return address from the hardware stack 26 after the processing of the external interrupt to thereby continue the processing of the instruction indicated by the return address.

The main controller 12 in this embodiment is in response to push and pop interrupt instructions supplied from the interrupt controller 18 over the control bus 22 to execute push and pop interrupt processing, respectively. During push interrupt processing, the main controller 12 sequentially retrieves data from the bottom of hardware stack 26 and pushes the retrieved data onto the software stack 28, the operation being repeated for a predetermined number of saving entries. During pop interrupt processing, the main controller 12 sequentially pops data from the software stack 28 and stores the popped data at the bottom of the hardware stack 26, the processing being also repeated for a predetermined number of restoring entries. The predetermined number of saving entries equals the predetermined number of restoring entries. In the description below, this number is referred to as the number of software stack storing entries.

In the instant embodiment, the main controller 12 can reference an internal address access register 30 provided in the hardware to access the entry at the bottom of the hardware stack 26. As shown in FIG. 2, the internal address access register 30 is included in the stack register 16. The main controller 12 issues a read instruction to the internal address access register 30 to retrieve data at the bottom of the hardware stack 26 and issues a write instruction to store data at the bottom of the hardware stack 26, as depicted with a reference numeral 34.

The ROM 14, preferably a non-volatile memory, is adapted to store program sequences each composed of a plurality of instructions such as operation instructions and subroutine call instructions. The ROM 14 in this embodiment also stores program sequences for push and pop interrupt processing to be executed by the main controller 12.

The stack register 16 is a type of data storage structure capable of storing a plurality of data entries. In this embodiment, the stack register 16 may contain, in the form of hardware stack 26 to or from which data required for program instruction execution are written in or read out at high speed, a program counter stack for storing a program counter for containing the return address of a processing routine such as a program subroutine or an interrupt processing routine, a loop counter stack for containing the number of multiply nested loops, and a loop end address stack for containing the loop end address of a loop.

The hardware stack 26 usually operates in the Last-In First-Out (LIFO) fashion in which the last written data are read out first. In the description, writing data onto the stack is referred to as pushing, and reading out data from the stack as popping.

In the illustrative embodiment, where the data entries stored in the hardware stack 26 have an equal number of bytes, dividing the total size or storage capacity of the hardware stack 26 by this number of bytes gives the maximum number for data entries that can be stored in the hardware stack 26. The hardware stack 26 overflows if the number of pushed data entries exceeds this maximum number for data entries.

As shown in FIG. 2, the stack register 16 in this embodiment also includes the internal address access register 30 and a status register 32. The internal address access register 30 contains two types of addresses: one is a read internal address that is the address of the data at the bottom of the hardware stack 26 and the other is a write internal address that is of the entry immediately next to the data at the bottom toward the end of the hardware stack 26. When a read instruction is issued from the main controller 12, the data at the bottom are read out from the hardware stack 26 based on the read internal address. When a write instruction is issued, data are written in the entry immediately following the data at the bottom of the hardware stack 26 based on the write internal address.

The stack register 16 can automatically decrement the pointer pointing to the read internal address in response to a read instruction, and increment the pointer pointing to the write internal address in response to a write instruction. If a read instruction is received when data are not stored in the hardware stack 26 or if a write instruction is received when data entries corresponding to the maximum number are stored in the hardware stack 26, the stack register 16 can then use the status register 32 to notify an error.

The interrupt controller 18 controls the stack pointer pointing to an entry in the stack register 16 over the control bus 22. The interrupt controller 18 also notifies an external interrupt, generated in response to an interrupt request from an external device such as a peripheral device, to the main controller 12 over the control bus 22. The interrupt controller 18 may have an external interrupt permission register that works as a flag register, not shown. In that case, the flag register contains a logical “1” or unity to permit an external interrupt and a logical “0” or null to inhibit an external interrupt. When an interrupt request is received from an external device, the interrupt controller 18 references this register. Only when the interrupt is permitted, notifies the external interrupt. The initial value of the external interrupt permission register is set to “1”.

The interrupt controller 18 in this embodiment primarily functions as monitoring the usage capacity of the hardware stack 26 to generate an interrupt, depending upon its usage monitored. For example, if the interrupt controller 18 determines that the number of free entries of the hardware stack 26 has reached the number of push-trigger entries, it generates a push interrupt. If the controller 18 determines that the number of free entries of the hardware stack 26 has reached the number of pop-trigger entries, it generates a pop interrupt. Such a generated interrupt is supplied to the main controller 12.

The interrupt controller 18 may be structured so that, immediately before sending a push or a pop interrupt notification, the interrupt controller 18 sets the external interrupt permission register to “0”, and when control is returned from the push or pop interrupt processing, appropriately, of the main controller 12, the interrupt controller 18 sets the external interrupt permission register to “1”.

The number of push- or pop-trigger entries determined by the interrupt controller 18 may be specified by the number of data entries that can be pushed onto the hardware stack 26. The number of push-trigger entries is represented in data entry number more than zero, and preferably equal to one entry of data. The number of pop-trigger entries ranges from the number of software stack storing entries plus one to the maximum number of data entries that can be stored in the hardware stack 26. The larger the number of software stack storing entries is, the larger the number of pop-trigger entries may be.

The interrupt controller 18 has a pop interrupt permission register that works as a flag register. This flag register contains “1” to permit a pop interrupt and “0” to inhibit a pop interrupt. The interrupt controller 18 may be adapted to reference this register when it determines that the number of free entries of the hardware stack 26 has reached the number of pop-trigger entries and to send the pop interrupt notification only when the interrupt is permitted. The initial value of the pop interrupt permission register is “0”.

This pop interrupt permission register is also controlled by the main controller 12. The main controller 12 may be adapted to check the number of data entries stored in the software stack 28 immediately before pop interrupt processing is terminated and to set the pop interrupt permission register to “0” only when the number of data entries is “0”.

The RAM 20 is used primarily as an operation or work memory for temporarily storing intermediate operational results or data. In particular, the RAM 20 in this embodiment has a saving data accumulation area, or software stack 28, for use by the main controller 12 during the push and pop interrupt processing. The software stack 28 works in the LIFO fashion.

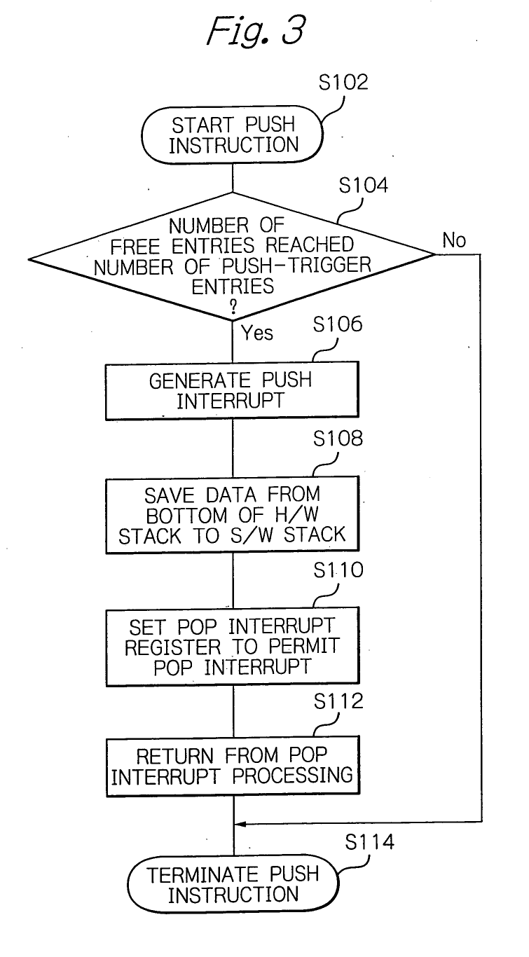

Next, the operation of the stack controller 10 in this embodiment will be described with reference to the flowchart, FIG. 3. The flowchart shows how data in the hardware stack 26 are saved when the interrupt controller 18 generates a push interrupt. In this example, it is assumed that both the number of push-trigger entries and the number of saving entries are one.

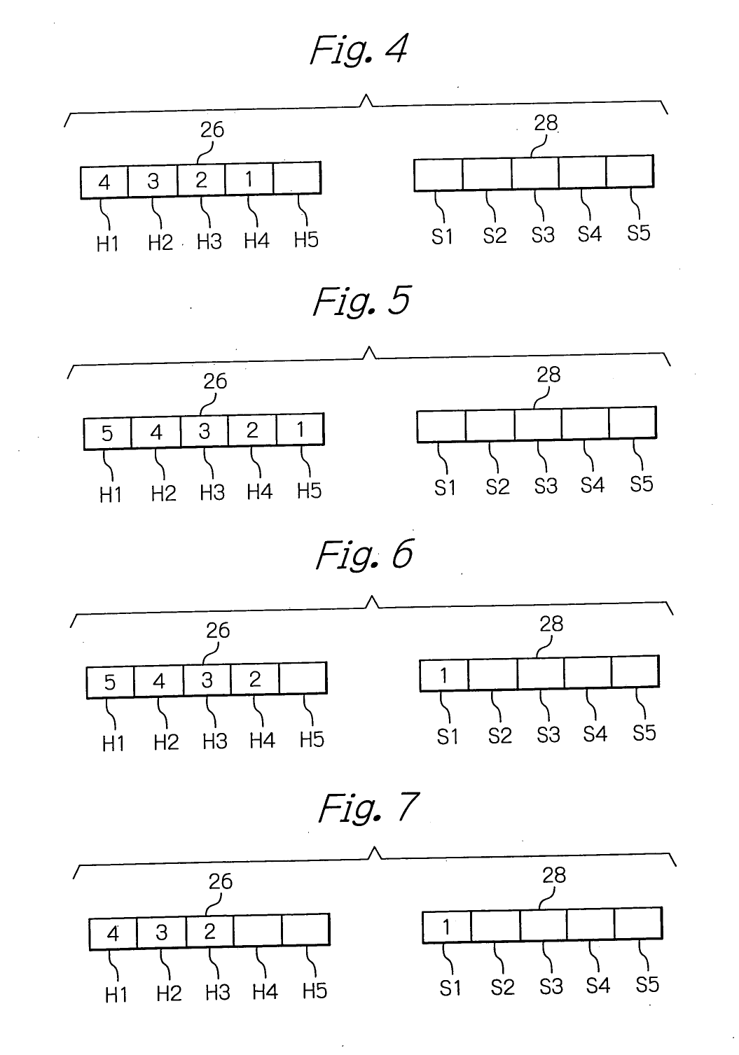

The hardware stack 26 in the stack register 16 of the stack controller 10 in the illustrative embodiment can store many data entries in practice. However, for convenience of description, the hardware stack 26 shown in FIG. 4 is structured to be capable of storing the maximum of five data entries in five data storage areas H1, H2, H3, H4 and H5. The leftmost entry of the hardware stack 26 in FIG. 4 is the top entry, and the rightmost entry is the bottom entry. When pushed on this hardware stack 26, a data entry is stored always in the top area H1 and the data entry stored in the area H1 is shifted to the area H2. Similarly, as a data item is pushed, the data items stored in the areas H2, H3 and H4 are respectively shifted to the areas H3, H4 and H5. In the hardware stack 26 shown in FIG. 4, the index numbers shown in the areas indicate the sequence in which data entries are pushed, and an area without index number indicates that no data entry is stored therein.

The software stack 28 in the RAM 20 in this embodiment is configured in the same way as the hardware stack 26. As shown in FIG. 4, the software stack 28 can store the maximum of five data entries in five data storage areas S1, S2, S3, S4 and S5. When a data entry is pushed on this software stack 28 and stored in the area S1, the data items stored in the areas S1, S2, S3 and S4 are respectively shifted to areas S2, S3, S4 and S5. The hardware stack 26 and the software stack 28 shown in FIGS. 5, 6 and 7 are configured in the same way as in FIG. 4.

In this embodiment, the main controller 12 executes the push instruction that pushes a data entry onto the hardware stack 26 (S102). This data entry is pushed onto the hardware stack 26 over the data bus 24.

The interrupt controller 18 monitors the number of free entries of the hardware stack 26 to check if the number of free entries has reached the number of push-trigger entries, step S104. If it is found as a result of this checking that the number of free entries of the hardware stack 26 has reached the number of push-trigger entries, that is, one entry of data, control is then passed to step S106. Otherwise, control is passed to step S114 to terminate the push instruction.

In the illustrative embodiment, if data entries are stored in the areas H1, H2, H3 and H4 of the hardware stack 26 and no data are stored in the area H5 in step S104 as shown in FIG. 4, it is then determined that the number of free entries is one and control is passed to step S106. Therefore, the number of free entries of the hardware stack 26 is never decreased to “0”. At this time, the software stack 28 stores no data.

Next, in step S106, the interrupt controller 18 generates a push interrupt, inhibits an external interrupt, and sets the external interrupt permission register to “0”. After that, the push interrupt is sent to the main controller 12 over the control bus 22.

In response to the push interrupt, the main controller 12 starts push interrupt processing. When control transfers to a function of executing the push interrupt processing, the return address is pushed onto the hardware stack 26 and, as shown in FIG. 5, the data entries are stored in all areas H1, H2, H3, H4 and H5 of the hardware stack 26 and the number of free entries becomes “0”.

Well, when the push interrupt processing is executed, the data entry stored at the bottom of the hardware stack 26 is saved into the software stack 28 (S108). Specifically, as shown in FIG. 6, the data entry stored in the area H5 is retrieved and pushed onto the area S1. This is repeated the number of times equal to the number of saving entries, that is, once in this example. As a result, the number of free entries of the hardware stack 26 becomes one, that is, the area H5.

When a data entry is pushed onto the software stack 28 as described above, it is necessary to prepare for a pop interrupt that will be generated later when the number of free entries of the hardware stack 26 reaches the number of pop-trigger entries as the processing progresses. Therefore, the main controller 12 causes the interrupt controller 18 to set “1” in the pop interrupt register (S110).

After that, when the push interrupt processing executed by the main controller 12 is terminated, the return address is popped from the hardware stack 26 and, as shown in FIG. 7, the number of free entries of the hardware stack 26 becomes two, that is, the areas H4 and H5. In addition, when control returns from the push interrupt processing, the interrupt controller 18 permits in step S112 an external interrupt that was inhibited in step S106, and sets the external interrupt permission register to “1”. Next, control is passed to step S114 to terminate the push instruction.

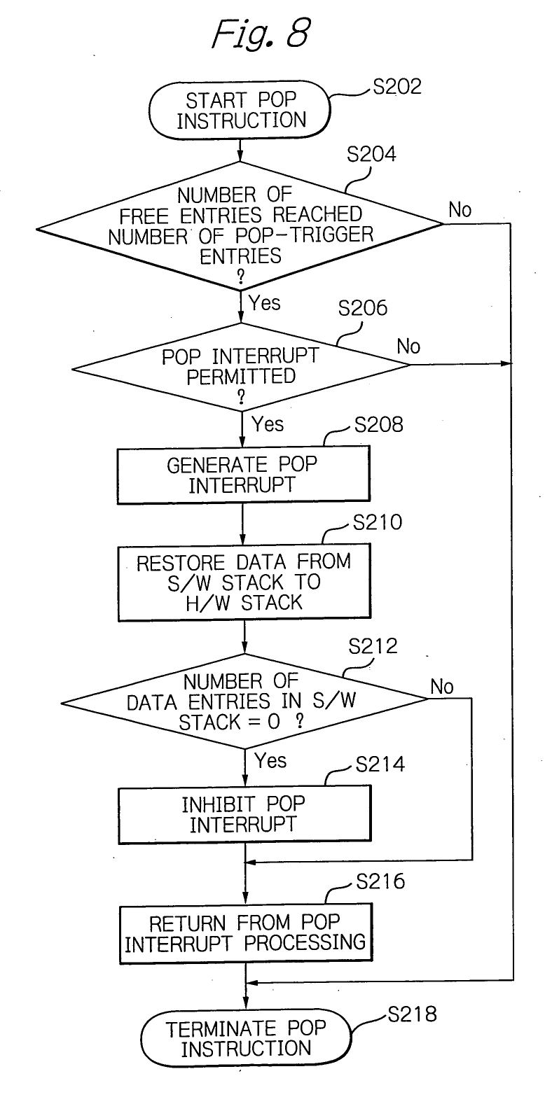

In the following, another operation of the stack controller 10 in this embodiment will be described with reference to the control flow shown in FIG. 8. In this operation, when the number of pop-trigger entries is three and the number of saving entries is one, the data entries saved in the software stack 28 are restored to the hardware stack 26 when the interrupt controller 18 generates a pop interrupt.

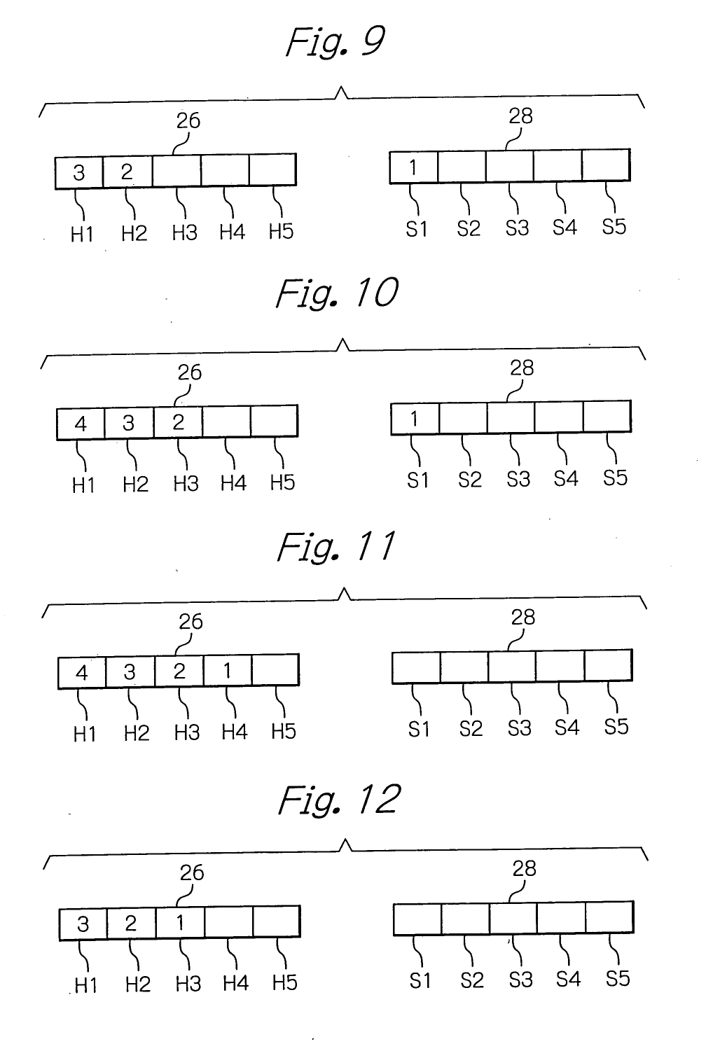

In this example, the hardware stack 26 and the software stack 28 shown in FIGS. 9, 10, 11 and 12 are configured in the same way as shown in FIG. 4. In the illustrative embodiment, the main controller 12 starts the pop instruction to pop data from the hardware stack 26 (S202) to pop one data entry from the hardware stack 26.

At this time, the interrupt controller 18 checks if the number of free entries of the hardware stack 26, which is being monitored, has reached the number of pop-trigger entries (S204). If it is found, as the result of this checking, that the number of free entries of the hardware stack 26 has reached the number of pop-trigger entries, that is, three entries of data are free, control is then passed to step S206. Otherwise, control is passed to S218 to terminate the pop instruction.

In step S204 in this embodiment, if the areas H1 and H2 of the hardware stack 26 store data entries and the areas H3, H4 and H5 store no data entry as shown in FIG. 9, the interrupt controller 18 determines that the number of free entries has reached three entries of data in step S204 and passes control to step S206. Note that the software stack 28 stores one data entry in the area S1 at this time.

Next, in step S206, the interrupt controller 18 checks if a pop interrupt is permitted, namely, if the pop interrupt permission register contains “1” or “0”. If the pop interrupt permission register contains “1”, control is passed to step S208, and otherwise control is passed to step S218 to terminate the pop instruction.

In step S208, the interrupt controller 18 generates a pop interrupt, inhibits an external interrupt, and sets the external interrupt permission register to “0”. After that, the pop interrupt is sent to the main controller 12 over the control bus 22.

In response to the pop interrupt, the main controller 12 starts pop interrupt processing. When control transfers to a function of executing the pop interrupt processing, the return address is pushed onto the hardware stack 26 and, as shown in FIG. 10, three data entries are stored in the areas H1, H2 and H3 of the hardware stack 26 and the number of free entries becomes two, that is, the areas H4 and H5.

Next, during the pop interrupt processing, the data entry stored at the top of the software stack 28 is restored to the bottom of the hardware stack 26 (S210). Specifically, the data entry stored in the area S1 is popped and is stored in the area H4 as shown in FIG. 11. This is repeated the number of times equal to the number of saving entries, that is, once in this example. After that, the number of data entries stored in the software stack 28 becomes “0”.

In addition, the number of free entries of the software stack 28 is checked during the pop interrupt processing (S212). If the number of free entries of the software stack 28 is five, that is, if no data entry is stored, control is passed to step S214. If one or more entries of data items are stored in the software stack 28, control is passed to step S216.

In step S214, the main controller 12 causes the interrupt controller 18 to inhibit the pop interrupt and to set the pop interrupt register to “0”, and then passes control to step S216. The reason for inhibiting the pop interrupt as described above is that the pop interrupt becomes useless in this case. This is because, even if the main controller 12 executes pop interrupt processing when the number of free entries of the hardware stack 26 has reached the number of pop-trigger entries, no data can be retrieved from the software stack 28 when no data entry is stored in the software stack 28.

The main controller 12 terminates the pop interrupt processing and pops the return address from the hardware stack 26 as described above. As a result, the number of free entries of the hardware stack 26 becomes two, that is, the areas H4 and H5, as shown in FIG. 12. When control is returned from the pop processing, the interrupt controller 18 permits an external interrupt (S216), which was inhibited in step S208, and sets the external interrupt permission register to “1”. Next, control is passed to step S218 to terminate the pop instruction.

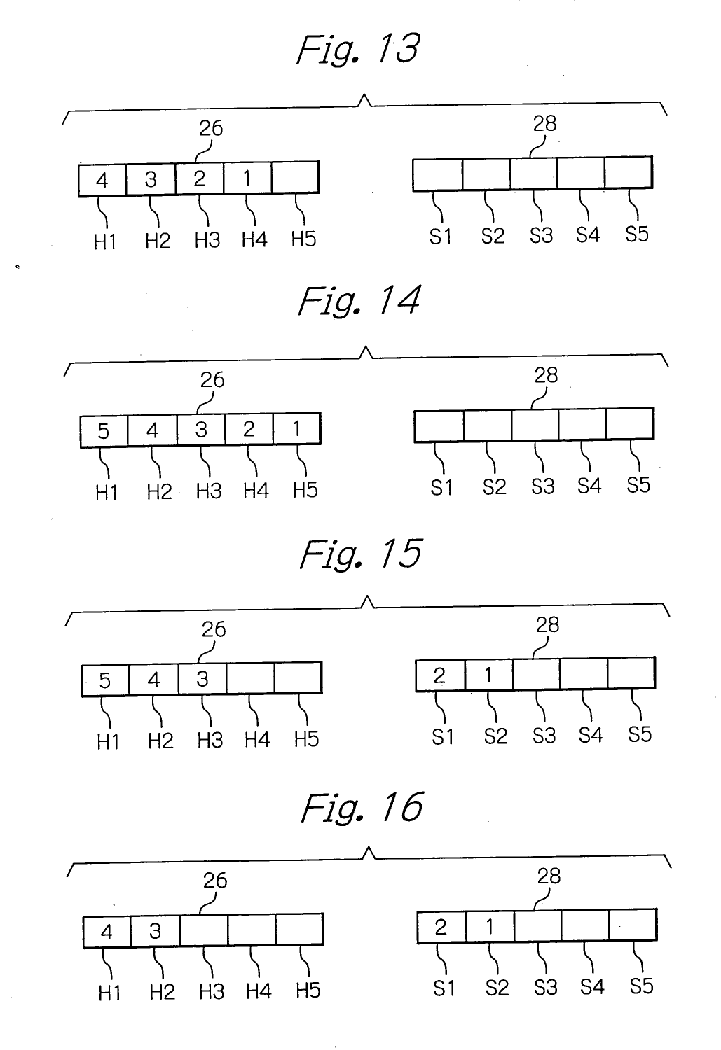

The operation of the stack controller 10 in this embodiment under another condition will be described by referring also to the flowchart, FIG. 3. In this example, the number of push-trigger entries is one and the number of saving entries is two. Under this condition, data are saved from the hardware stack 26 when the interrupt controller 18 generates a push interrupt. The data in the hardware stack 26 and the software stack 28 in this case are processed as shown in FIGS. 13, 14, 15 and 16. Note that the hardware stack 26 and the software stack 28 shown in those figures are configured in the same manner as shown in FIG. 4.

In this case, in steps S102 and S104 in FIG. 3, data are stored in the areas H1, H2, H3 and H4 of the hardware stack 26, and no data in the area H5, as shown in FIG. 13. No data are stored in the software stack 28.

In step S106, FIG. 3, the main controller 12 passes control to the function of executing the push interrupt processing to start push interrupt processing and pushes the return address onto the hardware stack 26. Data are stored in all areas (H1, H2, H3, H4 and H5) of the hardware stack 26 as shown in FIG. 14, and the number of free entries of the hardware stack 26 becomes “0”. At this time, too, no data are stored in the software stack 28.

Data stored at the bottom of the hardware stack 26 are saved into the software stack 28 in step S108, FIG. 3, and this save operation is repeated the number of times equal to the number of saving entries, i.e. twice for two entries of data. Therefore, data are stored in the areas H1, H2 and H3 of the hardware stack 26, and no data in the areas H4 and H5, as shown in FIG. 15.

In this case, data are sequentially retrieved from the bottom of the hardware stack 26 and are pushed onto the software stack 28. The data with index number “1”, which were stored in the area H5 of the hardware stack 26 before the push interrupt processing, are stored in the area S2 of the software stack 28, and the data with index number 2, which were stored in the area H4, are stored in the area S1. In this way, the two entries of data are saved in the areas S1 and S2 of the software stack 28.

The main controller 12 terminates the push interrupt processing after S110, FIG. 3, and pops the return address of the push interrupt processing from the hardware stack 26. Therefore, the data with the index number 5 are popped from the area H1 of the hardware stack 26 and, as shown in FIG. 16, data are stored in the areas H1 and H2. However, no data are in the areas H3, H4 and H5. In this case, the software stack 28 remains in the state shown in FIG. 15, i.e. in the state when step S110 was executed in the control flow shown in FIG. 3.

In step S112 and S114, FIG. 3, the data in the hardware stack 26 and the software stack 28 remain in the state shown in FIG. 16.

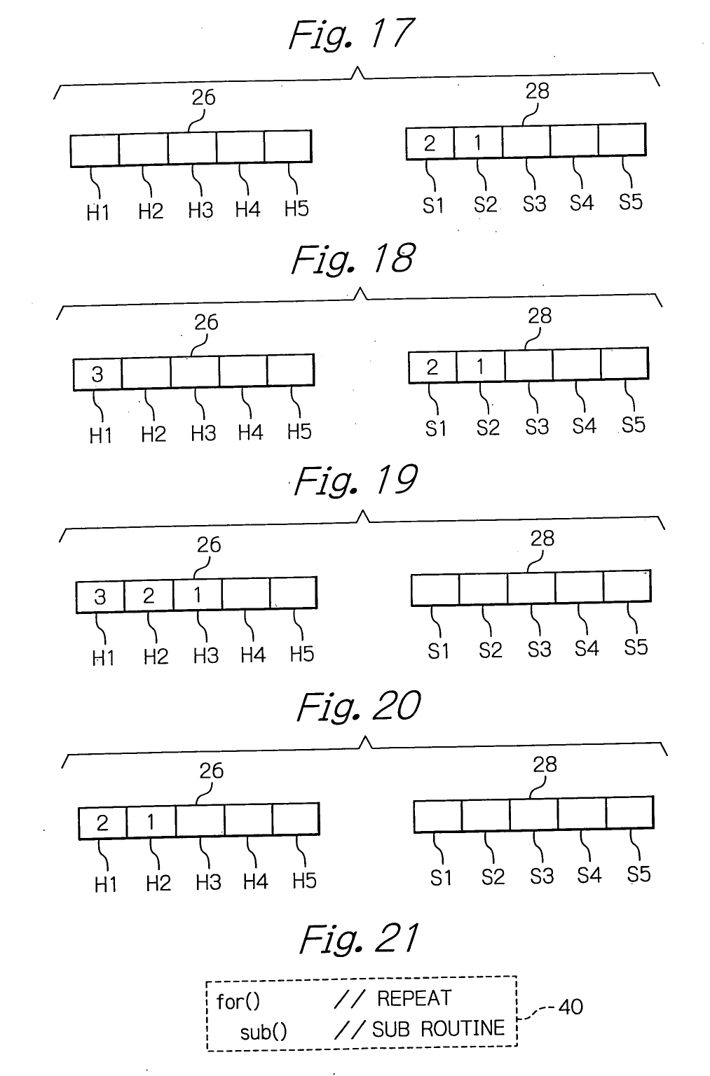

Now, the operation of the stack controller 10 in this embodiment under another condition will be described with reference also to the flowchart, FIG. 8. In this example, the numbers of pop-trigger entries and restoring entries are five and two, respectively. Under this condition, data are restored from the software stack 28, where the data are saved, to the hardware stack 26 when the interrupt controller 18 generates a pop interrupt. The data in the hardware stack 26 and the software stack 28 in this case are processed in the fashion depicted in FIGS. 17, 18, 19 and 20. Note that the hardware stack 26 and the software stack 28 shown in FIG. 17 through 20 are configured in the same manner as shown in FIG. 4.

In this case, in steps S202, S204 and S206, FIG. 8, no data are stored in the hardware stack 26 as shown in FIG. 17. in this stage, data are stored in the areas S1 and S2 of the software stack 28 whereas no data are stored in the areas S3, S4 and S5.

In step S208, FIG. 8, the main controller 12 passes control to the function of executing the pop interrupt processing to start pop interrupt processing and pushes the return address onto the hardware stack 26. Data are stored in the area H1 of the hardware stack 26, and no data are stored in the areas H2, H3, H4 and H5 as shown in FIG. 18. The software stack 28 remains in the state when step S206 was executed in the control flow shown in FIG. 8, that is, in the state shown in FIG. 17.

Data stored at the top of the software stack 28 are restored to the bottom of the hardware stack 26 in step S210, FIG. 8, and this restore operation is repeated the number of times equal to the number of restoring entries, that is, twice for two entries of data. Data are stored in the areas H1, H2 and H3 of the hardware stack 26, and no data in the areas H4 and H5, as shown in FIG. 19. At this time, no data are stored in the software stack 28.

In this case, data are sequentially popped from the software stack 28 and are stored at the bottom of the hardware stack 26. The data with index number 2, which were stored in the area S1 of the software stack 28 before the pop interrupt processing, are stored in the area H2 of the hardware stack 26, and the data with index number “1”, which were stored in the area S2, will be stored in the area H3. In this way, the two entries of data are restored from the software stack 28 to the areas H2 and H3.

In steps S212 and S214, FIG. 8, the data in the hardware stack 26 and the software stack 28 remain in the state shown in FIG. 19. The main controller 12 terminates the pop interrupt processing after step S214 and pops the return address of the pop interrupt processing from the hardware stack 26. Therefore, the data with the index number 3 are popped from the area H1 of the hardware stack 26, data are stored in the areas H1 and H2, whereas no data are stored in the areas H3, H4 and H5 as shown in FIG. 20. In this case, the software stack 28 remains in the state shown in FIG. 19.

In steps S216 and S218, FIG. 8, the data in the hardware stack 26 and the software stack 28 remain in the state shown in FIG. 20.

As described above, the stack controller according to the present invention can process data in the stacks according to various numbers of saving and restoring entries. Preferably, the minimum of the number of saving entries and the number of restoring entries required is one, and the maximum is an optimum value calculated by the expression
(maximum number of data entries of hardware stack−1)/2
with its decimal places rounded off. Although the number of saving entries and the number of restoring entries may exceed this optimum value, it is desirable that the number of saving or restoring entries be equal to or smaller than the calculated value in order to prolong the period to the next push interrupt or the next pop interrupt. If the number of restoring entries is larger than this optimum value, then the number of pop-trigger entries may be the maximum number of data entries of the hardware stack. Specifically, when data are popped from the hardware stack and the number of stored data entries has decreased to “0”, a pop interrupt may be generated.

If data are not saved from or restored to the stacks very frequently, a smaller number of saving entries and a smaller number of restoring entries may be used for the stack controller to save the cycles required for data movement. On the other hand, if a smaller number of saving entries and a smaller number of restoring entries are used for the stack controller when subroutines are called repeatedly and the hardware stack is almost used up, for example, when control is passed to an inner level of nested subroutines, a push interrupt and a pop interrupt would occur frequently with the result that the performance is decreased. In such a case, the number of saving entries and the number of restoring entries may preferably be increased.

For example, assume that a program sequence such as the one 40 shown in FIG. 21 is executed when the hardware stack 26 has the maximum of five data entries and the number of free entries is two. If the number of saving entries and the number of restoring entries are small, data will be saved to and restored from the stacks each time the subroutine is called. Conversely, if the number of saving entries and the number of restoring entries are large, the subroutine is called first and two entries of data are saved once from the hardware stack 26 to the software stack 28. After that, the processing is performed speedily using only the hardware stack 26, and therefore performance is kept high.

It is also possible for the stack controller according to the present invention to have a function of determining the optimum number of saving entries for the push interrupt processing and the optimum number of restoring entries for the pop interrupt processing. A program for determining the number of saving/restoring entries can be stored in the ROM 14 for execution by the main controller 12. In this case, when executing the push interrupt processing and the pop interrupt processing, the main controller 12 reads out the number of saving/restoring entries stored in a memory such as the RAM 20.

The main controller 12 also keeps running the program sequence for determining the number of saving/restoring entries, or executes the program sequence at a predetermined interval, to determine the optimum number of saving/restoring entries for the current processing and stores the number thus determined into the memory. This allows the main controller 12 to execute the push interrupt processing and the pop interrupt processing always using the optimum number of saving/restoring entries.

For example, the program sequence for determining the number of saving/restoring entries may be designed to determine the optimum number of saving/restoring entries according to the frequency at which data are saved to and restored from the stack. When data are saved to and restored from the stack frequently, the numbers of saving entries and restoring entries are increased to improve the performance. Conversely, when data are saved to or restored from the stack not very frequently, the numbers of saving entries and restoring entries are decreased to save the cycles required for data movement.

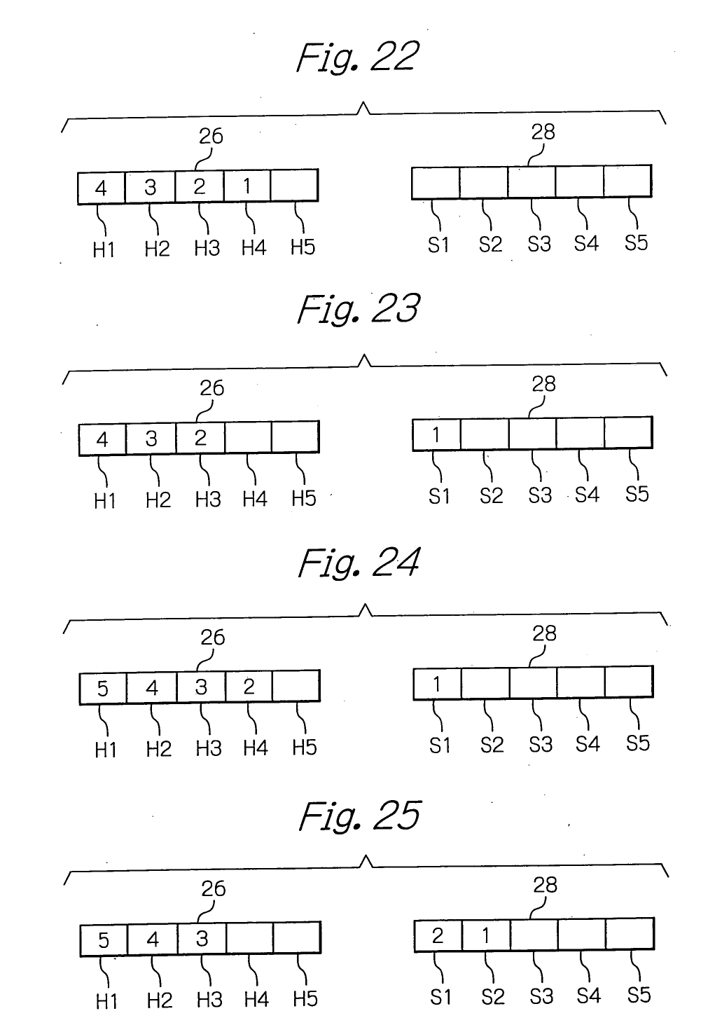

It will now be described how the stack controller 10, which is controlled by the program sequence for determining the number of saving/restoring entries, executes the push interrupt processing and the pop interrupt processing according to the frequency of saving, with reference to the processing of data in the hardware stack 26 and the software stack 28 shown in FIGS. 22-29. The hardware stack 26 and the software stack 28 shown in FIGS. 22-29 are configured in the same way as shown in FIG. 4. In this operation, the number of push-trigger entries, the number of pop-trigger entries, the number of saving entries, and the number of restoring entries are assumed initially to be one.

First, as shown in FIG. 22, data are stored in the areas H1, H2, H3 and H4, and no data in the area H5, of the hardware stack 26, while no data are stored in the software stack 28. In this case, the number of free entries of the hardware stack 26 is one, meaning that the number of push-trigger entries is reached. Therefore, a push interrupt is generated to save one entry of data at the bottom of the hardware stack 26 and, as shown in FIG. 23, the data in the area H4 of the hardware stack 26 are retrieved and pushed into the area S1 of the software stack 28.

Next, as shown in FIG. 24, a new data entry is pushed onto the hardware stack 26 and, as a result, data are stored in the areas H1, H2, H3 and H4. The number of free entries is one, that is, the area H5.

At this time, because the number of free entries of the hardware stack 26 has reached the number of push-trigger entries, a push interrupt is generated. The data at the bottom of the hardware stack 26 are saved for the number of saving entries, that is, one entry of data. As shown in FIG. 25, the data in the area H4 of the hardware stack 26 are retrieved and pushed into the area S1 of the software stack 28.

If the program sequence for determining the number of saving/restoring entries detects that a push interrupt is generated for one entry of data continuously for a predetermined number of times, the program increases the number of saving entries and the number of restoring entries, for example, to two and sets the number of pop-trigger entries to five.

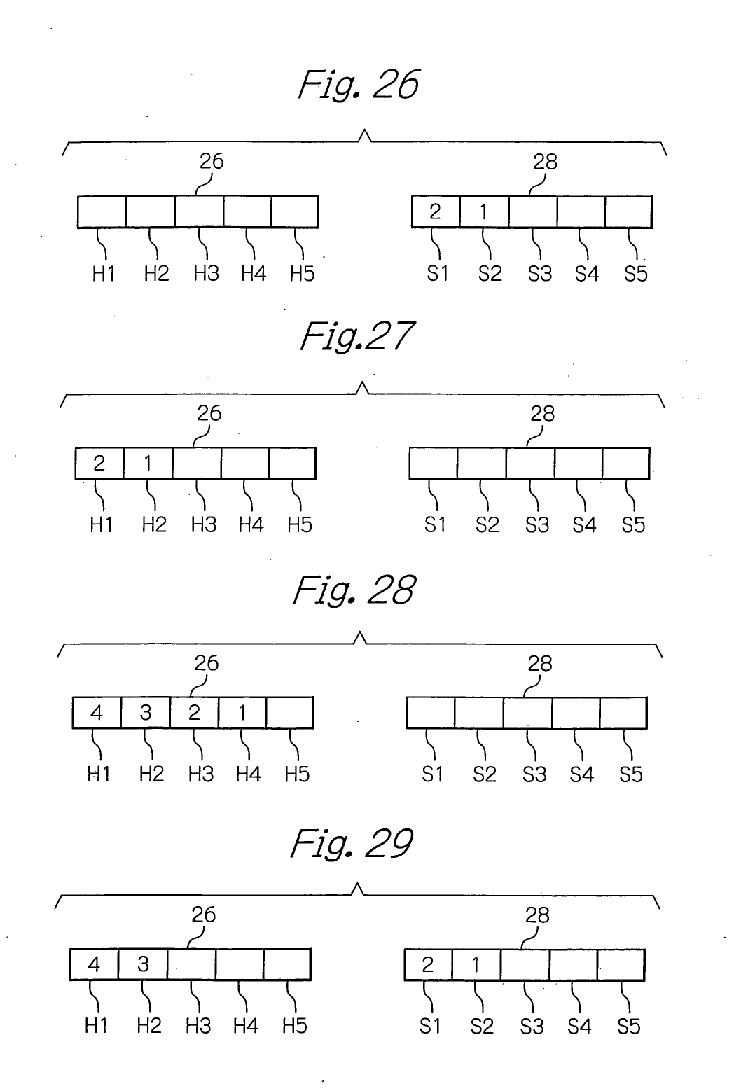

Later, as the operation progresses, the data are popped from the hardware stack 26 as shown in FIG. 26 and, as a result, the number of free entries of the hardware stack 26 becomes five, that is, the number of pop-trigger entries.

In this case, because the number of free entries of the hardware stack 26 is the number of pop-trigger entries, a pop interrupt is generated to restore data from the software stack 28 for the number of restoring entries, i.e. two. As shown in FIG. 27, data are popped from the areas S1 and S2 of the software stack 28 and stored in the areas H1 and H2 of the hardware stack 26.

Later, as the operation progresses, new data are pushed onto the hardware stack 26 as shown in FIG. 28 and, as a result, the number of free entries of the hardware stack 26 becomes one, that is, the number of push-trigger entries.

In this case, since the number of free entries of the hardware stack 26 is the number of push-trigger entries, a push interrupt is generated to save data from bottom of the hardware stack 26 for the number of saving entries, i.e. two. As shown in FIG. 29, data are retrieved from the areas H3 and H4 of the hardware stack 26 and pushed into the areas S1 and S2 of the software stack 28.

As described above, the program sequence for determining the number of saving/restoring entries, which is used by the stack controller, can adjust the number of saving/restoring entries to the optimum number of saving/restoring entries according to the frequency of saving and restoring, namely, according to the frequency of a push interrupt and a pop interrupt. In this case, the number of push-trigger entries and the number of pop-trigger entries may also be adjusted.

Although the program sequence for determining the number of saving/restoring entries uses the predetermined number of continuous push interrupts as the frequency condition in the instant embodiment, the frequency condition may also be an interval of time to the next push interrupt or the number of program sequences processed during the interval of time. The program sequence for determining the number of saving/restoring entries may also be designed to set the frequency condition, not for the push interrupt but the pop interrupt. The program sequence for determining the number of saving/restoring entries may also determine the optimum number of saving/restoring entries according to the location where the program is executed.

The illustrative embodiment has primarily been described with the stack controller according to the present invention applied to a microprocessor. Alternatively to a microprocessor, the stack controller and its control method according to the present invention may effectively be used in a data processing device, such as a micro-controller and a digital signal processor (DSP), where program sequences are stored and instructions are serially executed.

The entire disclosure of Japanese patent application No. 2005-131343 filed on Apr. 28, 2005, including the specification, claims, accompanying drawings and abstract of the disclosure is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

What is claimed is:

1. A stack controller comprising:
a main controller for executing a program sequence including a plurality of instructions such as an operation instruction and a subroutine call instruction;
a stack register having a first stack where first data are stored in a Last-In First-Out (LIFO) fashion, the first data including a program counter, a loop counter, and a loop end address of the program sequence; and
a storage circuit for temporarily storing second data such as an intermediate result processed by the operation instruction,
said storage circuit including a second stack where the first data are stored in the LIFO fashion,
said stack controller further comprising an interrupt controller for monitoring a capacity of the first stack, said interrupt controller generating, when a number of free entries of the first stack has reached a predetermined number of push-trigger entries, a push interrupt to send the generated push interrupt to said main controller, and, when the number of free entries has reached a predetermined number of pop-trigger entries, a pop interrupt to send the generated pop interrupt to said main controller,
said main controller comprising:
a push interrupt processor operative in response to the push interrupt for repeatedly retrieving data from a bottom of the first stack and then pushing the retrieved data onto the second stack a number of times equal to a predetermined number of saving entries; and
a pop interrupt processor operative in response to the pop interrupt for repeatedly popping data from the second stack and then storing the popped data at the bottom of the first stack a number of times equal to a predetermined number of restoring entries.

2. The stack controller in accordance with claim 1, wherein said interrupt controller comprises:
a first flag register for indicating a permission or inhibition of the pop interrupt; and
a second flag register for indicating a permission or inhibition of an external interrupt caused by an interrupt request from an external device such as a peripheral device,
said first flag register initially indicating the inhibition of the pop interrupt, said second flag register initially indicating the permission of the external interrupt,
said interrupt controller setting said second flag register to indicate the inhibition and generating a push interrupt when the number of free entries has reached the predetermined number of push-trigger entries, and thereafter setting said second flag register to indicate the permission when control is returned from the push interrupt,
said interrupt controller setting said second flag register to indicate the inhibition and generating a pop interrupt when the number of free entries has reached the predetermined number of pop-trigger entries and when said first flag register indicates the permission, and thereafter setting said second flag register to indicate the permission when control is returned from the pop interrupt,
said push interrupt processor setting said first flag register to indicate the permission when data are pushed onto the second stack,
said pop interrupt processor setting said first flag register to indicate the inhibition when data are popped from the second stack and when the number of data entries stored in the second stack is zero.

3. The stack controller in accordance with claim 1, wherein said stack register comprises an internal address access register having a read internal address and a write internal address, the read internal address being an address of data at the bottom of the first stack, the write internal address being an address shifted one data entry from the read internal address toward an end of the first stack,
said push interrupt controller accessing the read internal address in said internal address access register to retrieve data from the bottom of the first stack,
said pop interrupt processor accessing the write internal address in said internal address access register to store data at the bottom of the first stack.

4. The stack controller in accordance with claim 1, wherein the predetermined number of push-trigger entries corresponds to one entry of the first data,
said push interrupt processor being a first program sequence executable by said main controller,
said pop interrupt processor being a second program sequence executable by said main controller,
said main controller pushing, in response to the push interrupt, a first return address from the first program sequence onto the first stack and execute the first program sequence, and popping, when the first program sequence is terminated, the first return address from the first stack and returning control to an instruction indicated by the first return address,
said main controller pushing, in response to the pop interrupt, a second return address from the second program sequence onto the first stack, executing the second program sequence, and popping, when the second program sequence is terminated, the second return address from the first stack to return control to an instruction indicated by the second return address.

5. The stack controller in accordance with claim 1, wherein the predetermined number of pop-trigger entries ranges from one entry of the first data to a maximum of data entries of the first data that can be stored in the first stack,
each of the predetermined number of saving entries and the predetermined number of restoring entries ranging from one entry of the first data to a value equal to or smaller than a value calculated by an expression,
(the maximum of data entries−1)/2
with a decimal place rounded off.

6. The stack controller in accordance with claim 5, wherein each of the predetermined number of pop-trigger entries, the predetermined number of saving entries and the predetermined number of restoring entries corresponds to one entry of the first data.

7. The stack controller in accordance with claim 5, wherein the predetermined number of pop-trigger entries corresponds to all entries capable of being stored in the first stack,
each of the predetermined number of saving entries and the predetermined number of restoring entries being a value calculated by an expression,
(maximum of first data entries that can be stored in first stack−1)/2
with a decimal place rounded off.

8. The stack controller in accordance with claim 5, wherein said interrupt controller further comprises a frequency monitor for monitoring a frequency of the push interrupt or the pop interrupt, said interrupt controller determining and setting, based on the monitored frequency, optimum numbers of the pop-trigger entries, the predetermined number of saving entries and the predetermined number of restoring entries.

9. The stack controller in accordance with claim 8, wherein said frequency monitor usually sets the number of pop-trigger entries, the predetermined number of saving entries and the predetermined number of restoring entries to one entry of the first data,
said frequency monitor increasing the number of pop-trigger entries, the predetermined number of saving entries and the predetermined number of restoring entries when the push interrupt or the pop interrupt is generated continuously a predetermined number of times, and setting, when the number of data entries stored in the first stack is decreased to zero, the number of pop-trigger entries, the predetermined number of saving entries and the predetermined number of restoring entries again to one entry of the first data.

10. A stack control method comprising:
a first step of executing by a main controller a program sequence including a plurality of instructions such as an operation instruction and a subroutine call instruction;
a second step of storing first data in a first stack in a stack register in a LIFO fashion, said first data including a program counter, a loop counter, and a loop end address of the predetermined program sequence; and
a third step of temporarily storing second data, such as an intermediate result processed by the operation instruction, into a memory,
wherein said method further comprises:
a fourth step of storing the first data into a second stack in said memory in a Last-In First-Out (LIFO) fashion;
an interrupt control step of monitoring a capacity of the first stack to generate a push interrupt when a number of free entries of the first stack has reached a predetermined number of push-trigger entries and send the generated push interrupt to the main controller, and to generate a pop interrupt when the number of free entries has reached a predetermined number of pop-trigger entries and send the generated pop interrupt to the main controller;
a push interrupt processing step of being responsive to the push interrupt to repeatedly retrieve data, by said main controller, from a bottom of the first stack and then push the retrieved data onto the second stack a number of times equal to a predetermined number of restoring entries; and
a pop interrupt processing step of being responsive to the pop interrupt to repeatedly pop data, by said main controller, from the second stack and then store the popped data at the bottom of the first stack a number of times equal to a predetermined number of restoring entries.

11. The method in accordance with claim 10, wherein said interrupt control step comprises the substeps of:
using a first flag register to indicate a permission or inhibition of the pop interrupt and a second flag register to indicate a permission or inhibition of an external interrupt caused by an interrupt request from an external device such as a peripheral device, the first flag register initially indicating the inhibition of the pop interrupt, the second flag register initially indicating the permission of the external interrupt;
setting the second flag register to indicate the inhibition and generating a push interrupt when the number of free entries has reached the predetermined number of push-trigger entries, and thereafter setting the second flag register to indicate the permission when control is returned from the push interrupt; and
setting the second flag register to indicate the inhibition, and generating a pop interrupt when the number of free entries has reached the predetermined number of pop-trigger entries and when the first flag register indicates the permission, and thereafter setting the second flag register to indicate the permission when control is returned from the pop interrupt,
said push interrupt processing step further comprising the substep of setting the first flag register to indicate the permission when data are pushed onto the second stack,
said pop interrupt processing step further comprising the substep of setting the first flag register to indicate the inhibition when data are popped from the second stack and when the number of data entries stored in the second stack is zero.

12. The method in accordance with claim 10, wherein the stack register comprises an internal address access register having a read internal address and a write internal address, the read internal address being an address of data at the bottom of the first stack, the write internal address being an address shifted one data entry from the read internal address toward an end of the first stack,
said push interrupt processing step comprising the substep of accessing the read internal address, which is stored in the internal address access register in the stack register and is the address of data at the bottom of the first stack, to retrieve data from the bottom of the first stack,
said pop interrupt processing step comprising the substep of accessing the write internal address, which is stored in the internal address access register and is an address shifted one data entry from the read internal address toward the end of the first stack, to store data at the bottom of the first stack.

13. The method in accordance with claim 10, wherein the predetermined number of push-trigger entries corresponds to one entry of the first data,
said push interrupt processing step being executed by the main controller as a first program sequence, in which the main controller is in response to the push interrupt to push a first return address from the first program sequence onto the first stack and execute the first program sequence, and to pop, when the first program sequence is terminated, the first return address from the first stack and return control to an instruction indicated by the first return address,
said pop interrupt processing step being executed by the main controller as a second program sequence in which the main controller is in response to the pop interrupt to push a second return address from the second program sequence onto the first stack, and execute the second program sequence, and to pop, when the second program sequence is terminated, the second return address from the first stack to return control to an instruction indicated by the second return address.

14. The method in accordance of claim 10, wherein the predetermined number of pop-trigger entries ranges from one entry of the first data to a maximum of data entries of the first data that can be stored in the first stack and
each of the predetermined number of saving entries and the predetermined number of restoring entries ranging from one entry of the first data to a value equal to or smaller than a value calculated by an expression,
(the maximum of data entries−1)/2
with a decimal place rounded off.

15. The method in accordance with claim 14, wherein each of the predetermined number of pop-trigger entries, the predetermined number of saving entries and the predetermined number of restoring entries corresponds to one entry of the first data.

16. The method in accordance with claim 14, wherein the predetermined number of pop-trigger entries is all entries capable of being stored in the first stack,
each of the predetermined number of saving entries and the predetermined number of restoring entries being a value calculated by an expression,
(maximum of first data entries that can be stored in first stack−1)/2
with a decimal place rounded off.

17. The method in accordance with claim 14, wherein said interrupt control step further comprises a frequency monitor substep of monitoring a frequency of the push interrupt or the pop interrupt to determine and set, based on the monitored frequency, optimum numbers of the pop-trigger entries, the predetermined number of saving entries and the predetermined number of restoring entries.

18. The method in accordance with claim 17, wherein said frequency monitor step comprises the substep of usually setting the number of pop-trigger entries, the predetermined number of saving entries and the predetermined number of restoring entries to one entry of the first data, increasing the number of pop-trigger entries, the predetermined number of saving entries and the predetermined number of restoring entries when the push interrupt or the pop interrupt is generated continuously a predetermined number of times, and setting the number of pop-trigger entries, the predetermined number of saving entries and the predetermined number of restoring entries again to one entry of the first data when the number of data entries stored in the first stack is decreased to zero.
